(19) United States
(12) Patent Application Publication
(10) Pub. No.: US 2026/0017741 A1
(43) Pub. Date: Jan. 15, 2026

(54) AI EVALUATION PLATFORM FOR MUNICIPAL SOLID WASTE INCINERATION

(71) Applicant: Beijing University Of Technology, BEIJING (CN)

(72) Inventors: Jian TANG, BEIJING (CN); Tianzheng WANG, BEIJING (CN); Hao TIAN, BEIJING (CN); Mingjun SUN, BEIJING (CN); Yang BAI, BEIJING (CN); Shun CHENG, BEIJING (CN); Junfei QIAO, BEIJING (CN)

(21) Appl. No.: 19/010,523

(22) Filed: Jan. 6, 2025

(30) Foreign Application Priority Data
Jul. 15, 2024 (CN) 202410946558.2

(51) Int. Cl. G06Q 50/26

(52) U.S. Cl. CPC G06Q 50/26

(57) ABSTRACT

Provided is an artificial intelligence (AI) evaluation platform for municipal solid waste incineration (MSWI). The AI evaluation platform for municipal solid waste incineration includes: An AI-driven modeling system of multimodal data is connected to an AI optimization system for cloud-side safety isolation and a synchronous publishing system of multimodal historical data, the synchronous publishing system of multimodal historical data is connected to an AI control system for edge-side safety isolation, and the AI control system for edge-side safety isolation is connected to an AI control system of an end-side multiple-input multiple-output loop and the AI optimization system for cloud-side safety isolation. This application resolves, in conventional technologies, a problem that “AI+MSWI” digital industry clusters cannot implement safety collaboration on a cloud side, an edge side, and an end side, and a problem that MSWI plants are difficult to maintain stable optimization conditions for a long period of time.

### CROSS REFERENCE TO RELATED APPLICATION

This patent application claims the benefit and priority of Chinese Patent Application No. 202410946558.2, filed with the China National Intellectual Property Administration on Jul. 15, 2024, the disclosure of which is incorporated by reference herein in its entirety as part of the present application.

### TECHNICAL FIELD

The present disclosure relates to the field of municipal solid waste incineration (MSWI) technologies, and in particular to an artificial intelligence (AI) evaluation platform for municipal solid waste incineration (MSWI).

### BACKGROUND

Municipal solid waste incineration (MSWI) technologies have become one of the main technologies for treating municipal solid waste (MSW) due to advantages of harmlessness, minimization, and resource utilization. Because of differences between developing and developed countries in MSW components and management methods, the automatic combustion control system introduced is difficult to operate effectively in China. Currently, the MSWI process is mainly controlled manually by domain experts using empirical knowledge, to implement the stable control of the MSWI process. Apparently, this model has serious randomness and variability of experience of experts. Therefore, it is difficult to ensure that the MSWI plants are in a stable optimization working condition for a long period of time. As a result, incineration enterprises face challenges in intelligent operation and maintenance, improvement of quality and efficiency, industrial control safety, and the like, specifically including unpredictability and instability of the incineration process directly caused by randomness and variability in this model. Because operating habits, experience, and judgment standards of the domain experts are different, an operation in the same conditions may be processed in multiple different ways. When working conditions for different shifts of different operators fluctuate greatly, unified operating standards and specifications cannot be formulated. This affects the stability and consistency of the overall operation. In addition, the domain experts cannot uninterruptedly monitor and adjust the incineration process around the clock, and due to intermittency and hysteresis, the incineration efficiency is reduced and the discharged pollutants are increased. Therefore, in the face of unexpected situations and extreme conditions, the experts cannot deal with the problems by experience, and are easy to have an error in operation or slow in reacting. This further aggravates the instability of the working conditions. Because of the above problems, the MSWI plants are difficult to maintain stable optimization conditions, thereby affecting combination efficiency and pollution control effect, increasing operating costs and environmental risks, and resulting in accelerated aging of equipment and an increase in maintenance costs.

Incineration enterprises face challenges in AI empowerment, intelligent operation and maintenance, improvement of quality and efficiency, industrial control safety, and the like, specifically including: (1) Difficulty in efficient and stable control of the MSWI power plants is increased because of uncertain fluctuations in the compositions of municipal solid waste (MSW), large fluctuations in calorific value, and large-scale operational equipment. (2) Enterprises need to disclose pollutant emission data, to satisfy public supervision, environmental regulators carry out “unannounced inspection”, and penalties for exceeding environmental standards are increased. (3) New environmental requirements such as dual-carbon strategy, blue sky, and clean earth are increasingly stringent, and the enterprises need to assume sole responsibility for their profits or losses after the national subsidy is withdrawn. Therefore, the MSWI enterprises face the problems of how to implement a low-carbon transition, improve economic efficiency, and improve market competitiveness. (4) As a typical process industry, the MSWI process faces industrial control safety that is closely related to national security. The Network Security No. 14 Doc. “Guidelines for the Network Security Protection of Industrial Control Systems” issued by the Ministry of Industry and Information Technology in 2024 clearly points out that security management, security operations, technical protection, the implementation of the responsibility need to be conducted, and industrial firewalls and network gates need to be used, to ensure that the security of architecture and the border, security of the cloud, application security, and system data security. In addition, the Notice of the State Council on Issuing the “New Generation AI Development Plan” clearly points out that partial AI technologies and applications reach the world's leading level in 2025, and the world's major AI innovation and research center is to be constructed in 2030. The China News points out that the cloud-edge-end collaborative industries are stepping towards a new stage of deep applications. The latest government report points out that applications such as big data and AI need to be researched and developed, and an “AI+” program needs to be conducted.

In conclusion, there is, in the conventional technologies a problem that “AI+MSWI” digital industry clusters cannot implement safety collaboration on a cloud side, an edge side, and an end side, and a problem that MSWI plants are difficult to maintain stable optimization conditions for a long period of time.

### SUMMARY

In order to overcome the deficiencies of the prior art, an objective of the present disclosure is to provide an AI evaluation platform for municipal solid waste incineration (MSWI). The present disclosure resolves, in conventional technologies, a problem that “AI+MSWI” digital industry clusters cannot implement safety collaboration on a cloud side, an edge side, and an end side, and a problem that MSWI plants are difficult to maintain stable optimization conditions for a long period of time.

To achieve the above objective, the present disclosure provides the following technical solutions.

An AI evaluation platform for municipal solid waste incineration includes:
a synchronous publishing system of multimodal historical data, an AI technology evaluation system, and an AI-driven modeling system of multimodal data, an AI control system of an end-side multiple-input multiple-output loop, an AI control system for edge-side safety isolation, and an AI optimization system for cloud-side safety isolation that are all connected to the AI technology evaluation system, where
the AI-driven modeling system of multimodal data is connected to the AI optimization system for cloud-side safety isolation and the synchronous publishing system of multimodal historical data, the synchronous publishing system of multimodal historical data is connected to the AI control system for edge-side safety isolation, and the AI control system for edge-side safety isolation is connected to the AI control system of an end-side multiple-input multiple-output loop and the AI optimization system for cloud-side safety isolation; and
the synchronous publishing system of multimodal historical data is configured to obtain a first data source and a second data source, the first data source and the second data source both include: environmental index data, a controlled variable, a manipulated variable, left grate flame video data, and right grate flame video data, the AI-driven modeling system of multimodal data is configured to perform quantitative modeling on the first data source, to obtain a model set, the model set includes: a detection model, a prediction model, a recognition model, a combustion line quantification model, a first optimization model, and a second optimization model, the AI control system of an end-side multiple-input multiple-output loop is configured to implement a closed-loop operation of AI control of multiple-input multiple-output loop for simulating an industrial site, and the AI control system for edge-side safety isolation is configured to implement closed-loop control of a virtual controlled-object of an edge-side physical isolation mechanism by the second data source, the AI optimization system for cloud-side safety isolation is configured to implement closed-loop optimization for the virtual controlled-object based on a cloud-side forward and reverse safety isolation mechanism, and the AI technology evaluation system is configured to evaluate the AI-driven modeling system of multimodal data, the AI control system of an end-side multiple-input multiple-output loop, the AI control system for edge-side safety isolation, the AI optimization system for cloud-side safety isolation, to obtain a final evaluation result.

The present disclosure has the following technical effect.

The AI evaluation platform for municipal solid waste incineration provided in the present disclosure includes: a synchronous publishing system of multimodal historical data, an AI technology evaluation system, and an AI-driven modeling system of multimodal data, an AI control system of an end-side multiple-input multiple-output loop, an AI control system for edge-side safety isolation, and an AI optimization system for cloud-side safety isolation that are all connected to the AI technology evaluation system, where the AI-driven modeling system of multimodal data is connected to the AI optimization system for cloud-side safety isolation and the synchronous publishing system of multimodal historical data, the synchronous publishing system of multimodal historical data is connected to the AI control system for edge-side safety isolation, and the AI control system for edge-side safety isolation is connected to the AI control system of an end-side multiple-input multiple-output loop and the AI optimization system for cloud-side safety isolation; and the synchronous publishing system of multimodal historical data is configured to obtain a first data source and a second data source, the first data source and the second data source both include: environmental index data, a controlled variable, a manipulated variable, left grate flame video data, and right grate flame video data, the AI-driven modeling system of multimodal data is configured to perform quantitative modeling on the first data source, to obtain a model set, the model set includes: a detection model, a prediction model, a recognition model, a combustion line quantification model, a first optimization model, and a second optimization model, the AI control system of an end-side multiple-input multiple-output loop is configured to implement a closed-loop operation of the AI control system of an end-side multiple-input multiple-output loop, and the AI control system for edge-side safety isolation is configured to implement closed-loop control of a virtual controlled-object of an edge-side physical isolation mechanism by the second data source, the AI optimization system for cloud-side safety isolation is configured to implement closed-loop optimization for the virtual controlled-object based on a cloud-side forward and reverse safety isolation mechanism, and the AI technology evaluation system is configured to evaluate the AI-driven modeling system of multimodal data, the AI control system of an end-side multiple-input multiple-output loop, the AI control system for edge-side safety isolation, the AI optimization system for cloud-side safety isolation, to obtain a final evaluation result. In the present disclosure: (1) a framework of cloud-edge-end platform for AI technology evaluation of an MSWI process is provided for the first time. (2) For multi-layer security isolation for data transmission, a two-layer security isolation method (isolation of end-side and edge-side, and isolation of edge-side and cloud-side) is used to implement the encryption and complete inspection of production data and operation parameters during an end-side collection process and an edge-side/cloud-side transmission process. (3) For stimulation and synchronization of multimodal data in real time, the multimodal data is synchronously acquired and stored based on multi-systems and multi-modules, to resolve the problem that it is difficult to perform cognitive modeling on the multimodal data in the industrial field. (4) For true expandability verified by multi-loops, a multi-loop program can be written via an embedded module of a real mainstream controller, and an advanced control algorithm can be written using high-level language, to implement intelligent control. (5) The modular design is easy to transplant, and a cloud-edge-end platform is constructed based on an open architecture and modular ideas. Therefore, transplantation efficiency of the AI algorithm is improved, and secondary development costs of a software system are reduced. (6) Long-term stable optimization conditions of the MSWI plants are improved.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a schematic diagram of a structure of an AI evaluation platform for municipal solid waste incineration according to an embodiment of the present disclosure;

FIG. 2 is a schematic diagram of a structure of a synchronous publishing system of multimodal historical data according to an embodiment of the present disclosure;

FIG. 3 is a schematic diagram of a structure of an AI-driven modeling system of multimodal data according to an embodiment of the present disclosure;

FIG. 4 is a schematic diagram of a structure of an AI control system of an end-side multiple-input multiple-output loop according to an embodiment of the present disclosure;

FIG. 5 is a schematic diagram of a structure of an AI control system for edge-side safety isolation according to an embodiment of the present disclosure;

FIG. 6 a schematic diagram of a structure of an AI optimization system for cloud-side safety isolation according to an embodiment of the present disclosure; and

FIG. 7 is a schematic diagram of a structure of an AI technology evaluation system according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure clearer and more comprehensible, the present disclosure will be further described in detail below with reference to the accompanying drawings and the specific implementations.

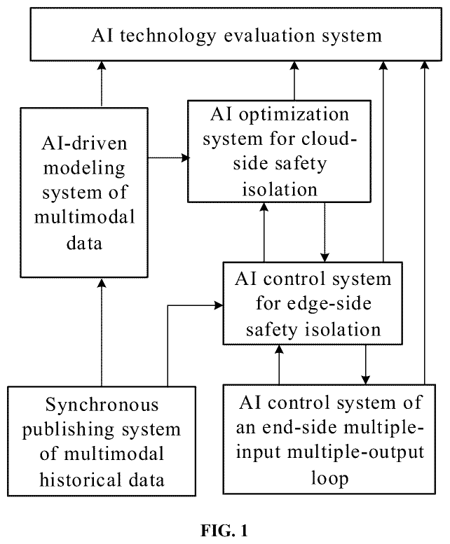

As shown in FIG. 1, an AI evaluation platform for municipal solid waste incineration includes:
a synchronous publishing system of multimodal historical data, an AI technology evaluation system, and an AI-driven modeling system of multimodal data, an AI control system of an end-side multiple-input multiple-output loop, an AI control system for edge-side safety isolation, and an AI optimization system for cloud-side safety isolation that are all connected to the AI technology evaluation system, where
the AI-driven modeling system of multimodal data is connected to the AI optimization system for cloud-side safety isolation and the synchronous publishing system of multimodal historical data, the synchronous publishing system of multimodal historical data is connected to the AI control system for edge-side safety isolation, and the AI control system for edge-side safety isolation is connected to the AI control system of an end-side multiple-input multiple-output loop and the AI optimization system for cloud-side safety isolation; and
the synchronous publishing system of multimodal historical data is configured to obtain a first data source and a second data source, the first data source and the second data source both include: environmental index data, a controlled variable, a manipulated variable, left grate flame video data, and right grate flame video data, the AI-driven modeling system of multimodal data is configured to perform quantitative modeling on the first data source, to obtain a model set, the model set includes: a detection model, a prediction model, a recognition model, a combustion line quantification model, a first optimization model, and a second optimization model, the AI control system of an end-side multiple-input multiple-output loop is configured to implement a closed-loop operation of the AI control system of an end-side multiple-input multiple-output loop, and the AI control system for edge-side safety isolation is configured to implement closed-loop control of a virtual controlled-object of an edge-side physical isolation mechanism by the second data source, the AI optimization system for cloud-side safety isolation is configured to implement closed-loop optimization for the virtual controlled-object based on a cloud-side forward and reverse safety isolation mechanism, and the AI technology evaluation system is configured to evaluate the AI-driven modeling system of multimodal data, the AI control system of an end-side multiple-input multiple-output loop, the AI control system for edge-side safety isolation, the AI optimization system for cloud-side safety isolation, to obtain a final evaluation result.

Specifically, for the AI control system of an end-side multiple-input multiple-output loop, an input is an optimized preset value, derived from the controlled variable, of the AI control system for edge-side safety isolation, an optimized parameter of an end-side AI control model, an optimized value of the manipulated variable, and the like; and an output is a feedback value of the controlled variable. For the AI control system for edge-side safety isolation, an input is a feedback value, derived from a controlled variable, of the AI control system of an end-side multiple-input multiple-output loop, and the multimodal data of the synchronous publishing system of multimodal historical data; and an output is an optimized preset value of a controlled variable obtained by the AI optimization system for cloud-side safety isolation through optimization, an optimized parameter of the end-side AI control model obtained by the AI control system for edge-side safety isolation, an optimized value of the manipulated variable. For the AI optimization system for cloud-side safety isolation, an input is output values of different models of the AI-driven modeling system of multimodal data, and a feedback value of the controlled variable of the AI control system for edge-side safety isolation; and an output is an optimized preset value of the controlled variable obtained by the AI optimization system for cloud-side safety isolation through optimization.

Specifically, an actual scenario in which domain experts recognize a change trend in the key process parameter based on the structural data and a flame video is simulated, to provide an engineering validation platform for multimodal data-driven modeling. A multi-layer safety isolation device is used to implement unidirectional transmission of data, to provide an intelligent algorithm with an engineering verification environment, that is, provide support for forward acquisition of data source, and provide an operational optimization parameter for reverse transmission. A control hierarchy structure that is the same as a control hierarchy structure in an actual industrial field is adopted, the actuator and the instrumentation device are simulated via hardware and software, to implement the engineering validation for a control algorithm for a multiple-input multiple-output loop, thereby performing comprehensive evaluation of modeling, control, and optimization algorithms for the AI technology, and promoting the implementation of AI+MSWI. The synchronous publishing system of multimodal historical data provides multimodal data support for the AI-driven modeling system of multimodal data and the AI control system for edge-side safety isolation. The AI control system of an end-side multiple-input multiple-output loop and the AI control system for edge-side safety isolation exchange control data, to implement closed-loop control of the virtual controlled-object. The AI-driven modeling system of multimodal data provides model support for the AI optimization system for cloud-side safety isolation, and performs optimization data exchange between the AI control system for edge-side safety isolation and the AI optimization system for cloud-side safety isolation, to implement closed-loop optimization of the virtual controlled-object. The AI technology evaluation system acquires input and output data of the AI-driven modeling system of multimodal data, the AI optimization system for cloud-side safety isolation, the AI control system for edge-side safety isolation, and the AI control system of an end-side multiple-input multiple-output loop, to implement comprehensive evaluation of AI modeling, control, and the optimization technology of the MSWI process.

More specifically: (1) Synchronous publishing system of multimodal historical data: including a network time synchronization service subsystem, a subsystem for publishing a historical right grate flame video, a subsystem for publishing a historical left grate flame video, and a subsystem for publishing historical structural data, used to simulate an actual scenario of synchronously generating structural data and a flame video of an actual MSWI, thereby providing a data source for multimodal data-driven modeling system and a control system for edge-side safety isolation.

(2) AI-driven modeling system of multimodal data: including a subsystem for structural modeling processing on multimodal data, a difficultly-to-be-measured parameter detection subsystem, a key process parameter prediction subsystem, a combustion state recognition subsystem, a combustion line state quantification subsystem, an environmental index optimization modeling subsystem, and a manipulated variable optimization modeling subsystem, and used to a modeling-oriented pre-processing on the multimodal data, perform quantitative modeling on key controlled variables such as a trace pollutant, a furnace temperature, and a flame combustion state, and perform optimization modeling on conventional pollutants such as SO₂, NOₓ, and CO₂, and manipulated variables of air distribution and material distribution.

(3) AI control system of an end-side multiple-input multiple-output loop: including a subsystem for aid decision-making of an operation parameter, a process monitoring subsystem, a loop control subsystem, and a virtual controlled-object subsystem, and adopting the control hierarchy structure that is the same as the control hierarchy structure in the actual industrial field, and simulating the actuator, the controlled-object, and the instrumentation device via software and hardware, to implement a closed-loop operation controlled by the end-side multiple-input multiple-output loop.

(4) AI control system for edge-side safety isolation: including a subsystem for forward isolation for edge-side data acquisition, an edge-side AI-enabled safety control subsystem, and a subsystem for reverse transmission of an edge-side operation parameter, and used to implement the closed-loop control of the virtual controlled-object based on an edge-edge-side physical isolation mechanism.

(5) AI optimization system for cloud-side safety isolation: including a subsystem for safe forward access on a cloud side, a cloud-side AI-enabled safety optimization subsystem, and a subsystem for safe reverse transmission on a cloud side, and used to implement the closed-loop optimization of the virtual controlled-object based on the cloud-side forward and reverse safety isolation mechanism.

(6) AI technology evaluation system: including a subsystem for evaluation of an end-side AI control algorithm for multiple types of furnaces, a subsystem for evaluation of an edge-side AI control algorithm for multiple types of furnaces, a subsystem for evaluation of a cloud-side AI optimization algorithm for multiple types of furnaces, a subsystem for evaluation of an AI-driven modeling algorithm for multimodal data, and a subsystem for comprehensive evaluation of an AI technology for municipal solid waste incineration, and used to acquire input and output data of the AI-driven modeling system of multimodal data, the AI optimization system for cloud-side safety isolation, the AI control system for edge-side safety isolation, and the AI control system of an end-side multiple-input multiple-output loop, thereby implementing comprehensive evaluation of AI modeling, control, and the optimization technology of the MSWI process.

Further, the synchronous publishing system of multimodal historical data includes:
a network time synchronization service subsystem, and a subsystem for publishing historical structural data, a subsystem for publishing a historical left grate flame video, and a subsystem for publishing a historical right grate flame video that are all connected to the AI-driven modeling system of multimodal data and the network time synchronization service subsystem; and
the network time synchronization service subsystem is configured to unify clock signals of the subsystem for publishing historical structural data, the subsystem for publishing a historical left grate flame video, and the subsystem for publishing a historical right grate flame video, the network time synchronization service subsystem is configured to simulate, in real time, publishing of the environmental index data, the controlled variable, and the manipulated variable based on the clock signals, the subsystem for publishing a historical left grate flame video is configured to simulate, in real time, publishing of the left grate flame video data based on the clock signals, and the subsystem for publishing a historical right grate flame video is configured to simulate, in real time, publishing of the right grate flame video data based on the clock signals.

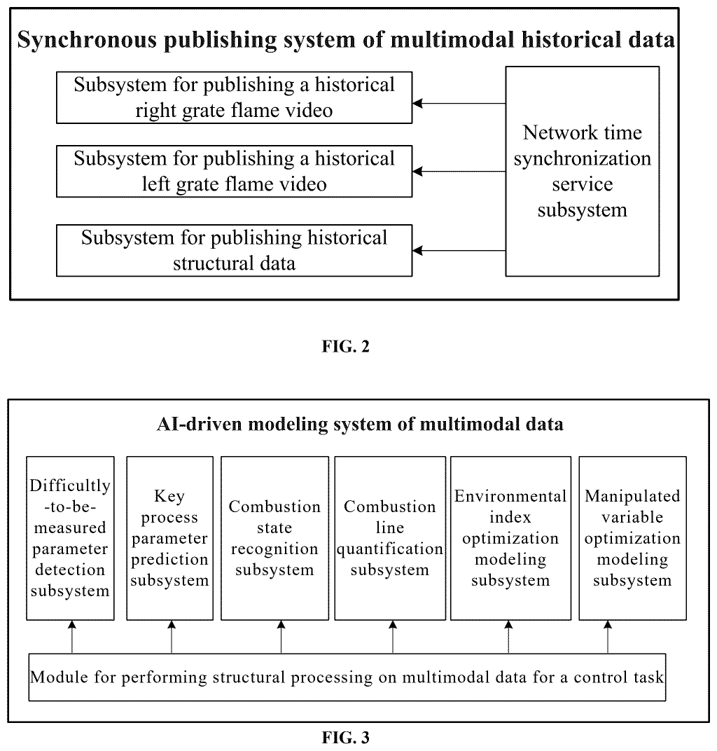

Specifically, a network time synchronization service device is used to synchronize the publishing of a right grate flame video, a left grate flame video, and the historical structural data that are used to simulate the actual MSWI process, to provide the simulated real-time data support for the perceptual and cognitive modeling of the domain experts in a simulated industrial field. The structure is shown in FIG. 2.

Network time synchronization service subsystem: unifying network times of the subsystem for publishing historical structural data, the subsystem for publishing a historical left grate flame video, and the subsystem for publishing a historical right grate flame video based on a Beidou satellite system, to ensure the real-time simulation of the publishing of the multimodal data of the MSWI industrial field, thereby ensuring credibility and effectiveness of a subsequent AI modeling algorithm.

Subsystem for publishing historical structural data: simulating real-time publishing of manipulated variables such as air distribution and material distribution, controlled variables such as a furnace temperature and oxygen content of a flue gas, and conventional environmental indices such as SO₂, NOₓ, CO, and CO₂ in a typical working condition in the industrial field via an OPC server and a MySQL database based on the clock signals of network time synchronization service subsystem, to simulate an industrial scenario in which the MSWI structural data is generated in real time.

Subsystem for publishing a historical left grate flame video: simulating real-time publishing of a left grate flame video that is in a typical working condition of the industrial field and that corresponds to the historical structural data via multimedia playback software based on the clock signal of the network time synchronization service subsystem, thereby simulating an industrial scenario in which an MSWI process flame video is generated in real time.

Subsystem for publishing a historical right grate flame video: simulating real-time publishing of a right grate flame video that is in a typical working condition of the industrial field and that corresponds to the historical structural data via multimedia playback software based on the clock signal of the network time synchronization service subsystem, thereby simulating an industrial scenario in which an MSWI process flame video is generated in real time.

Further, the AI-driven modeling system of multimodal data includes:
a subsystem for structural modeling processing on multimodal data, a difficultly-to-be-measured parameter detection subsystem, a key process parameter prediction subsystem, a combustion state recognition subsystem, a combustion line state quantification subsystem, an environmental index optimization modeling subsystem, and a manipulated variable optimization modeling subsystem; and
the subsystem for structural modeling processing on multimodal data is configured to perform physical feature extraction and neural network feature extraction on the first data source, to obtain multimodal structural data, the difficultly-to-be-measured parameter detection subsystem is configured to construct the detection model based on the multimodal structural data, the key process parameter prediction subsystem is configured to construct the prediction model based on the multimodal structural data, the combustion state recognition subsystem is configured to construct the recognition model based on the multimodal structural data, the combustion line state quantification subsystem is configured to construct the combustion line quantification model based on the multimodal structural data, the environmental index optimization modeling subsystem is configured to construct the first optimization model based on the multimodal structural data, and the manipulated variable optimization modeling subsystem is configured to construct the second optimization model based on the multimodal structural data.

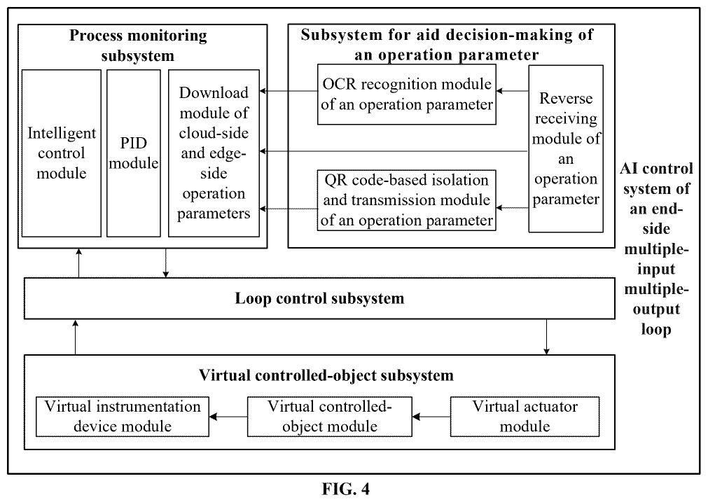

Specifically, after structural processing is performed on the multimodal data such as the flame video and the structural data, a difficultly-to-be-measured parameter detection model is constructed for trace pollutants, a prediction model is constructed for the key process parameters such as a furnace temperature and oxygen content of a flue gas, a combustion state recognition and combustion line quantification model is constructed, an optimization model for environmental indices such as SO₂, NOR, CO, and CO₂ is constructed, and an optimization model for manipulated variables such as air distribution and material distribution is conducted, to obtain a multimodal data-driven multipurpose AI model that can represent the perception, cognition, and decision-making of the domain experts. The structure is shown in FIG. 3.

Subsystem for structural modeling processing on multimodal data: based on requirements for difficultly-to-be-measured parameter detection modeling, key industrial parameter prediction modeling, combustion state recognition modeling, combustion line quantification, environmental index optimization modeling, and manipulated variable optimization modeling, extracting physical features of the flame video such as brightness, color, and texture, and deep neural network features with special semantics, and processing the physical features and the deep neural network features into structural features that all have a time scale the same as the manipulated variables such as air distribution and material distribution, the controlled variables such as the furnace temperature and the oxygen content of the flue gas, and the conventional environmental indices such as SO₂, NOₓ, CO, and CO₂, thereby providing support for constructing a multipurpose AI model.

Difficultly-to-be-measured parameter detection subsystem: based on environmental indices such as trace organic pollutants and quality indices such as a clinker ignition loss that are difficult to be detected online in real time, performing dimensionality reduction on the multimodal structural data provided by the subsystem for structural modeling processing on multimodal data, and then constructing the difficultly-to-be-measured parameter detection model based on algorithms such as statistical learning, a shallow/deep neural network, a tree/forest, and the like, thereby providing data support for the AI optimization system for cloud-side safety isolation and the AI technology evaluation system.

Key process parameter prediction subsystem: based on the controlled variables such as the furnace temperature and the oxygen content of the flue gas, and the conventional environmental indices such as SO₂, NOₓ, CO, and CO₂ that may be detected in real time, simulating a perception and cognition mechanism of the domain experts on site, performing dimensionality reduction on the multimodal structural data provided by the subsystem for structural modeling processing on multimodal data, and then constructing a key process parameter prediction model based on algorithms such as statistical learning, a shallow/deep neural network, a tree/forest, and the like, thereby providing data support for the AI optimization system for cloud-side safety isolation and the AI technology evaluation system.

Combustion state recognition subsystem: based on a local information combustion state divided according to a position of a combustion line and a global information combustion state divided according to an overall image, simulating perception and cognition mechanism of the domain experts on site, performing dimensionality reduction on the multimodal structural data provided by the subsystem for structural modeling processing on multimodal data, and then constructing a combustion state recognition model based on algorithms such as statistical learning, a shallow/deep neural network, a tree/forest, and the like, thereby providing data support for the AI optimization system for cloud-side safety isolation and the AI technology evaluation system.

Combustion line quantification subsystem: based on a position of a combustion line that may represent a combustion state quantitative characterization, performing quantification on a position of a combustion line of a complete flame combustion line template library, simulating a visual perception mechanism of the field experts, to implement quantification of the key controlled variable, namely, the combustion line, completing the combustion line template library based on knowledge of the field experts and technologies such as generation of an adversarial network, and updating an algorithm based on a twin network and an adaptive template, to implement quantification (a value between 0 and 100% is used to quantify the position of the combustion line) of the combustion line, thereby providing data support for the AI optimization system for cloud-side safety isolation and the AI technology evaluation system.

Environmental index optimization modeling subsystem: based on trace organic pollutants and environmental indices such as SO₂, NOₓ, CO, and CO₂ that are difficult to be detected online in real time, and based on the multimodal structural data provided by the subsystem for structural modeling processing on multimodal data, and laboratory analysis and statistical data of the incineration process, constructing an environmental index optimization model under a multi-time scale and multi-conflict target (an example of multi-scale is that the trace organic pollutant has a value every 2 hours, and the conventional pollutant has a value every minute; and an example of a multi-conflict target is that combustion efficiency is maximum, and a pollutant index is minimum), to provide data support for the AI optimization system for cloud-side safety isolation and the AI technology evaluation system.

Manipulated variable optimization modeling subsystem: based on manipulated variables such as a feed rate, a grate speed, a primary/secondary air volume, and an air temperature, and based on the multimodal structural data provided by the subsystem for structural modeling processing on multimodal data and the knowledge of the domain experts, constructing a manipulated variable optimization model simulating the knowledge of the domain experts, to provide the data support for the AI optimization system for cloud-side safety isolation and the AI technology evaluation system.

Further, the AI control system of an end-side multiple-input multiple-output loop includes:
a subsystem for aid decision-making of an operation parameter, a process monitoring subsystem, a loop control subsystem, and a virtual controlled-object subsystem; and
the subsystem for aid decision-making of an operation parameter is configured to: acquire an operation parameter, and transmit the operation parameter to the process monitoring subsystem, the process monitoring subsystem is configured to perform multi-loop AI control on the operation parameter, the loop control subsystem is configured to implement a plurality of different types of loop control programs, and the virtual controlled-object subsystem is configured to simulate an actuator, a controlled-object, and an instrumentation device of an MSWI process that is difficult to be constructed in a laboratory.

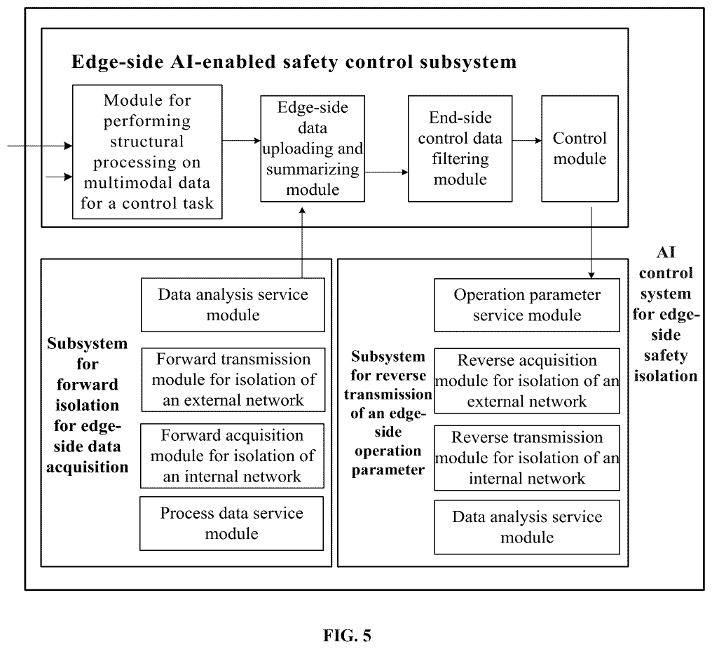

Specifically, the AI control system of an end-side multiple-input multiple-output loop adopts the control hierarchy structure that is the same as the control hierarchy structure in the actual industrial field, and simulates the actuator, the controlled-object, and the instrumentation device via software and hardware, to implement a closed-loop operation of AI control of the end-side multiple-input multiple-output loop. The structure is shown in FIG. 4.

Subsystem for aid decision-making of an operation parameter: The subsystem for aid decision-making of an operation parameter includes a reverse receiving module of an operation parameter, an OCR recognition module of an operation parameter, and a QR code-based isolation and transmission module of an operation parameter, where the operation parameter is transmitted, based on an operation parameter that is derived from the subsystem for reverse transmission of an edge-side operation parameter and acquired by the reverse receiving module of an operation parameter, to the process monitoring subsystem using any one of the three methods, namely, direct transmission, OCR recognition for an operation parameter, and QR code-based isolation and transmission for an operation parameter. The OCR recognition for an operation parameter is implemented by a camera device and a text recognition device, and the QR code-based isolation and transmission for an operation parameter is implemented by recognizing code and decode of QR code in a manner of simulating human eye recognition, and constructing a one-way isolation channel based on a non-contact one-way import device.

Process monitoring subsystem: The process monitoring subsystem includes a download module of cloud-side and edge-side operation parameters, a PID module, and an intelligent control module, and downloads the cloud-side and edge-side operation parameters via practical generalized control configuration and interface configuration software of a PLC/DCS manufacturer, where the download module of cloud-side and edge-side operation parameters is used to manually or automatically download cloud-side and edge-side operation parameters to a PLC/DCS controller, the PID module is used to perform multi-loop control via a standard PID module provided by a PLC/DCS system, and the intelligent control module is used to perform multi-loop AI control using a scripting language and a high-level language.

Loop control subsystem: constructing a logic loop control and AI control system based on a PLC/DCS device of an actual manufacturer, and running different types of loop control programs.

Virtual controlled-object subsystem: The virtual controlled-object subsystem includes a virtual actuator module, a virtual controlled-object module, and a virtual instrumentation device module, and is used to simulate an actuator, a controlled-object, and an instrumentation device of an MSWI process that is difficult to be constructed in a laboratory, thereby providing effective support for the operation of a multiple-input multiple-output loop control system. The virtual actuator module and the instrumentation device module interact data with the loop control subsystem in a hard-wired manner, and the virtual controlled-object module is used to simulate the incineration process by constructing a data-driven model.

Further, the AI control system for edge-side safety isolation includes:
a subsystem for forward isolation for edge-side data acquisition, an edge-side AI-enabled control subsystem, and a subsystem for reverse transmission of an edge-side operation parameter; and
the subsystem for forward isolation for edge-side data acquisition is configured to: acquire structural data, and publish the structural data to the edge-side AI-enabled safety control subsystem, the edge-side AI-enabled control subsystem is configured to transmit structural data processed by an AI algorithm to the subsystem for reverse transmission of an edge-side operation parameter, and the subsystem for reverse transmission of an edge-side operation parameter is configured to output the structural data to the subsystem for aid decision-making of an operation parameter.

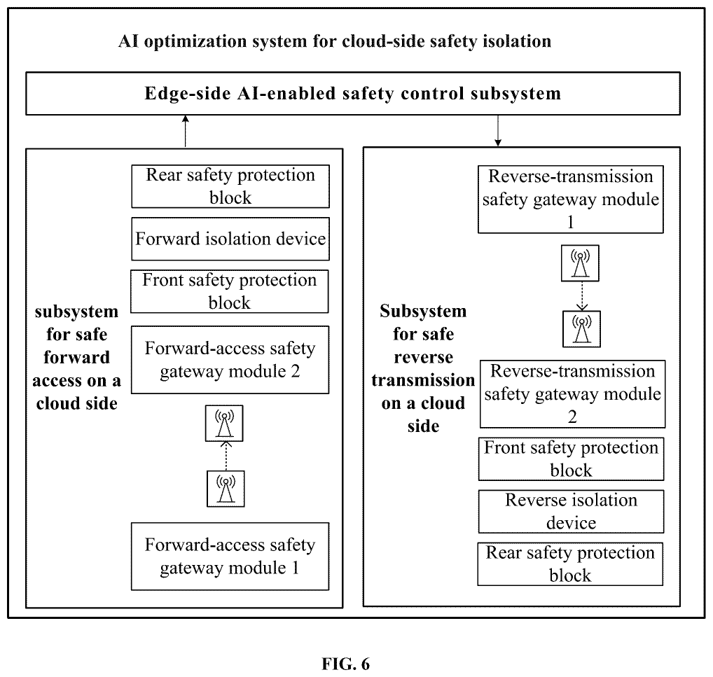

Specifically, the AI control system for edge-side safety isolation: implementing closed-loop control of the virtual controlled-object based on the edge-side physical isolation mechanism according to forward isolation for data acquisition, AI safety empowerment control, and reverse transmission of the operation parameter. The structure is shown in FIG. 5.

Subsystem for forward isolation for edge-side data acquisition: The subsystem for forward isolation for edge-side data acquisition includes a structural data service module, a forward acquisition module for isolation of an internal network, a forward transmission module for isolation of an external network, and a data analysis service module. The structural data service module is used to acquire structural data from an OPC server of a PLC/DCS control system in the multiple-input multiple-output loop control system. The forward acquisition module for isolation of an internal network is used to publish the structural data and a data acquisition configuration file to an external network end through a unidirectional transmission fiber. The forward transmission module for isolation of an external network is used to receive structural data and a data acquisition configuration file from an internal network acquisition computer through a unidirectional fiber, to provide data service to a local area network on an edge-side in the form of OPC communication. The data analysis service module is used to acquire structural data published from the external network as required, and transmit the structural data to the edge-side AI-enabled safety control subsystem.

Edge-side AI-enabled control subsystem: The edge-side AI-enabled control subsystem includes a module for performing structural processing on multimodal data for a control task, an edge-side data uploading and summarizing module, an end-side control data filtering module, and a control module. The module for performing structural processing on multimodal data for a control task is used to perform vectorization on unstructured data features such as a flame video, and convert the unstructured data features into structural data, thereby meeting a requirement for low-cost remote transmission of data The edge-side data uploading and summarizing module is used to summarize data from the module for performing structural processing on multimodal data for a control task and data from the subsystem for forward isolation for edge-side data acquisition, and upload the data to the subsystem for safe forward access on a cloud side. The end-side control data filtering module is used to select, from the edge-side data uploading and summarizing module, input data for an AI algorithm required for end-side control. The control module is used to receive data from the edge-side data uploading and summarizing module and data from the subsystem for safe reverse transmission on a cloud side, and transmit the data to the subsystem for reverse transmission of an edge-side operation parameter after the data is run according to the AI algorithm.

Subsystem for reverse transmission of an edge-side operation parameter: The subsystem for reverse transmission of an edge-side operation parameter includes an operation parameter service module, a reverse acquisition module for isolation of an external network, a reverse transmission module for isolation of an internal network, and a data analysis service module. The operation parameter service module is used to acquire operation parameter data provided by the control module in the edge-side AI-enabled safety control subsystem. The reverse acquisition module for isolation of an external network is used to publish the operation parameter data and a data acquisition configuration file to an internal network end through a unidirectional transmission fiber. The reverse transmission module for isolation of an internal network is used to receive the operation parameter data and a data acquisition configuration file from an edge-side external network end through a unidirectional fiber, to provide data service to a local area network on an edge-side in the form of OPC communication. The data analysis service module is used to acquire structural data published by the reverse transmission module for isolation of an internal network, and transmit the structural data to the subsystem for aid decision-making of an operation parameter.

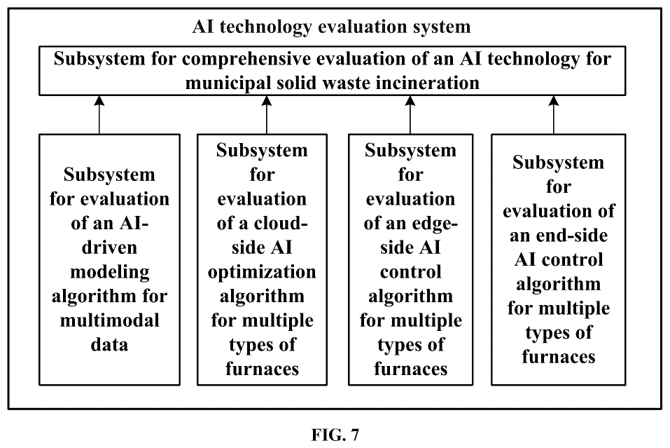

Further, the AI optimization system for cloud-side safety isolation: implementing closed-loop optimization of the virtual controlled-object based on the cloud-side forward and reverse safety isolation mechanism according to cloud-side safety forward access, cloud-side AI safety empowerment optimization, and cloud-side safety reverse transmission, as shown in FIG. 6.

Subsystem for safe forward access on a cloud-side: The subsystem for safe forward access on a cloud-side includes a forward-access safety gateway module 1, a forward-access safety gateway module 2, a front safety protection block, a forward isolation device, and a rear safety protection block. The cloud-side includes a forward-access safety gateway module 1 and the forward-access safety gateway module 2 receive, using a 5G encrypted receiving device via an operator network based on a wireless signal, a real-time encrypted data file of an MSWI process sent by the edge-side AI-enabled safety control subsystem. The forward isolation device that includes the front safety protection block, the forward isolation device, and the rear safety protection block, and the protection module read a data file of the 5G encrypted receiving device, and perform industrial safety isolation, to meet requirements of the cloud-side AI-enabled safety optimization subsystem.

Cloud-side AI-enabled optimization subsystem: The cloud-side AI-enabled optimization subsystem is used to acquire data from the subsystem for safe forward access on a cloud-side, store the data in a database of a cloud server, and perform operations on the data, such as time scale correction, abnormal data checking, and filling of missing data, to provide, based on a digital twin model, data support for modeling, control, optimization, and decision-making calculations in a cloud-side in combination with various models provided by the AI-driven modeling system of multimodal data. The cloud-side AI-enabled optimization subsystem includes a prediction model that fuses historical data with real-time data and that is capable of learning online and performing self-organization on update and a controlled-object model, performs collaborative optimization on a whole MSWI process using an intelligent optimization algorithm, to obtain an optimal process parameter meeting a current working condition, and uses algorithms such as a fault diagnosis algorithm to monitor a state at a current moment and predict an operation evolution and a state at a future moment, and outputs related operation parameters to the subsystem for safe reverse transmission on a cloud-side.

Subsystem for safe reverse transmission on a cloud-side: The subsystem for safe reverse transmission on a cloud-side includes a reverse-transmission safety gateway module 1, a reverse-transmission safety gateway module 2, a front safety protection block, a reverse isolation device, and a rear safety protection block. The reverse-transmission safety gateway module 1 and the reverse-transmission safety gateway module 2 receive, using a 5G encrypted receiving device via an operator network based on a wireless signal, an operation parameter of an MSWI process sent by the cloud-side AI-enabled optimization subsystem. The reverse isolation device that includes the front safety protection block, the reverse isolation device, and the rear safety protection block, and the protection module read a data file of the 5G encrypted receiving device, and perform industrial safety isolation, to serve the edge-side AI-enabled safety control subsystem.

Further, the AI technology evaluation system includes:
a subsystem for comprehensive evaluation of an AI technology for municipal solid waste incineration, a subsystem for evaluation of an AI-driven modeling algorithm for multimodal data, a subsystem for evaluation of a cloud-side AI optimization algorithm for multiple types of furnaces, a subsystem for evaluation of an edge-side AI control algorithm for multiple types of furnaces, and a subsystem for evaluation of an end-side AI control algorithm for multiple types of furnaces; and
the subsystem for evaluation of an AI-driven modeling algorithm for multimodal data is configured to: evaluate the AI-driven modeling system of multimodal data, to obtain a first evaluation sub-result, the subsystem for evaluation of an end-side AI control algorithm for multiple types of furnaces is configured to: evaluate the AI control system of an end-side multiple-input multiple-output loop, to obtain a second evaluation sub-result, the subsystem for evaluation of an edge-side AI control algorithm for multiple types of furnaces is configured to: evaluate the AI control system for edge-side safety isolation, to obtain a third evaluation sub-result, the subsystem for evaluation of a cloud-side AI optimization algorithm for multiple types of furnaces is configured to evaluate the AI optimization system for cloud-side safety isolation, to obtain a fourth evaluation sub-result, and the subsystem for comprehensive evaluation of an AI technology for municipal solid waste incineration is configured to obtain a final evaluation result based on the first evaluation sub-result, the second evaluation sub-result, the third evaluation sub-result, and the fourth evaluation sub-result.

Specifically, the AI technology evaluation system acquires input and output data of the AI-driven modeling system of multimodal data, the AI optimization system for cloud-side safety isolation, the AI control system for edge-side safety isolation, and the control system for an end-side multiple-input multiple-output loop, to implement comprehensive evaluation of AI modeling, control, and the optimization technology of the MSWI process. The structure is shown in FIG. 7.

Subsystem for comprehensive evaluation of an AI technology for municipal solid waste incineration: The subsystem for comprehensive evaluation of an AI technology for municipal solid waste incineration performs comprehensive evaluation of an AI-driven modeling algorithm for multimodal data, a cloud-side AI optimization algorithm for multiple types of furnaces, an edge-side AI control algorithm for multiple types of furnaces, and an end-side AI control algorithm for multiple types of furnaces (modeling may be performed using a deep neural network and a deep forest; the optimization algorithm may be of particle swarm optimization; and the control algorithm may be of neural network control and model prediction control). An evaluation value may be obtained using the formula below:

$$\begin{matrix}{ζ}_{sum} = {f}_{score} ( {f}_{Multi\_mod} ( \cdot ) , {f}_{MIMO\_contr} ( \cdot ) , {f}_{Security\_edg} ( \cdot ) , {f}_{Security\_edg} ( \cdot ) , {f}_{Security\_clou} ( \cdot ) ) \\ \{ \begin{matrix}{ζ}_{sum} = {λ}_{1} {ξ}_{mod}^{score} + {λ}_{2} {ξ}_{contr}^{score} + {λ}_{3} {ξ}_{edg}^{score} + {λ}_{4} {ξ}_{clou}^{score} \\ {ξ}_{mod}^{score} = {f}_{Multi\_mod} ( y , {y}_{mod} , γ , {γ}_{mod} , u , {u}_{mod} , {P}_{mod}^{y} , {P}_{mod}^{γ} , {P}_{mod}^{u} ) \\ {ξ}_{contr}^{score} = {f}_{MIMO\_contr} ( y , {y}_{contr}^{*} , {P}_{contr}^{y} ) \\ {ξ}_{edg}^{score} = {f}_{Security\_edg} ( γ , {y}_{edg}^{*} , {P}_{edg}^{y} ) \\ {ξ}_{clou}^{score} = {f}_{Security\_clou} ( γ , {γ}_{opi}^{*} , {P}_{opi}^{γ} )\end{matrix}\end{matrix} \qquad ( 1 )$$

ζₛᵤₘ represents a total evaluation score of the AI technology;

$${ξ}_{mod}^{score} , {ξ}_{conr}^{score} , {ξ}_{edg}^{score} , and {ξ}_{clou}^{score}$$

repressively represent evaluation scores of AI modeling, end-side AI control, edge-side AI control, and cloud-side AI optimization technology, and λ₁, λ₂, λ₃, and λ₄ repressively represent corresponding coefficients, λ₁+λ₂+λ₃+λ₄=1 and each value is between 0 and 1; f_{Multi_mod}(⋅), f_{MIMO_contr}(⋅), f_{Security_edg}(⋅), and f_{security_clou}(⋅) repressively correspond to the AI-driven modeling system of multimodal data, the AI control system of an end-side multiple-input multiple-output loop, the AI control system for edge-side safety isolation, and the AI optimization system for cloud-side safety isolation; y and ŷ_{mod} represent a true value and a predicted value corresponding to an AI modeling algorithm model based on a controlled variable, γ and \hat{γ}_{mod} represent a true value and a predicted value corresponding to an AI modeling algorithm model based on an operation index, u and û_{mod} represent a true value and a predicted value corresponding to an AI modeling algorithm model based on a manipulated variable, and

$${P}_{mod}^{y} , {P}_{mod}^{γ} , and {P}_{mod}^{u}$$

represent modeling parameters used by the AI modeling algorithm model based on the controlled variable, the operation index, and the manipulated variable; y and y*_{contr} represent a true value and a preset value corresponding to an AI control algorithm based on an end-side controlled variable, and

$${P}_{contr}^{y}$$

represents a modeling parameter used by the end-side AI control algorithm model; Y*_{edg} represents the preset value corresponding to an AI control algorithm for an edge-side controlled variable, and

$${P}_{edg}^{y}$$

represents a modeling parameter used by the edge-side AI control algorithm model; and γ and γ*ₑₚᵢ represents a true value and a preset value corresponding to the cloud-side AI optimization algorithm, and

$${P}_{opi}^{γ}$$

represents a modeling parameter used by the cloud-side AI optimization algorithm model.

Subsystem for evaluation of an AI-driven modeling algorithm for multimodal data: The subsystem for evaluation of an AI-driven modeling algorithm for multimodal data performs evaluation of performance of the AI-driven modeling system of multimodal data in a qualitative and quantitative manner based on domain expert experience. Regression models for the difficultly-to-be-measured parameter detection subsystem, the key process parameter prediction subsystem, the combustion line quantification subsystem, the environmental index optimization modeling subsystem, and the manipulated variable optimization modeling subsystem use indicators such as a root mean square error (RMSE) and a determining coefficient (R2), and the combustion state recognition subsystem uses indicators such as accuracy, precision, and recall. The qualitative manner is to score by domain experts.

Subsystem for evaluation of a cloud-side AI optimization algorithm for multiple types of furnaces: The subsystem for evaluation of a cloud-side AI control algorithm for multiple types of furnaces performs evaluation of performance of the AI optimization algorithm for multiple types of furnaces in a qualitative and quantitative manner based on domain expert experience. For the quantitative evaluation, expect that the evaluation indicator for an AI regression modeling algorithm is used to evaluate a preset optimization target value, indicators such as a mean best fitness (MBF), an average evaluated solution (AES), and a success rate (SR) are used to evaluate the optimization algorithm. The qualitative manner is to score by domain experts.

Subsystem for evaluation of an edge-side AI control algorithm for multiple types of furnaces: evaluating performance of the edge-side AI control algorithms for different types of furnaces in a qualitative and quantitative manner based on domain expert experience. Quantitative evaluation indicators include an integral of absolute error (IAE), a maximum deviation (Devmax) of a preset value, a relative tracking error (RTE), and the like. Corresponding calculation formulas are as follows.

$${IAE}_{edg} = \frac{1}{{t}_{f}} {\sum }_{t = 1}^{{t}_{f}} \vert {y}_{edg}^{*} - y \vert , \qquad ( 2 )$$

$${Dev}_{edg}^{max} = max ( \vert {y}_{edg}^{*} - {y}_{1} \vert , … , \vert {y}_{edg}^{*} - {y}_{{t}_{f}} \vert ) , \qquad ( 3 )$$

$${RTE}_{edg} = {\sum }_{t = 1}^{{t}_{f}} \frac{\vert {y}_{edg}^{*} - {y}_{t} \vert}{{y}_{edg}^{*}} , \qquad ( 4 )$$

t_{f} represents a maximum number of iterations of an edge-side controller, and t represents a tth iteration, with a value from 1 to t_{f}; yₜ, represents a value of a controlled variable at a tth iteration of the edge-side controller; and yₜ_{_{f}} represents a value of the controlled variable at a t_{f}th iteration of the edge-side controller.

Subsystem for evaluation of an end-side AI control algorithm for multiple types of furnaces: evaluating performance of the end-side control algorithms for different types of furnaces in a qualitative and quantitative manner based on domain expert experience. Quantitative evaluation indicators include IAE, Devmax, RTE, and the like. Corresponding calculation formulas are as follows.

$${IAE}_{contr} = \frac{1}{{t}_{f}} {\sum }_{t = 1}^{{t}_{f}} \vert {y}_{contr}^{*} - y \vert , \qquad ( 5 )$$

$${Dev}_{cont}^{max} = max ( \vert {y}_{contr}^{*} - {y}_{1} \vert , … , \vert {y}_{contr}^{*} - {y}_{{t}_{f}} \vert ) , \qquad ( 6 )$$

$${RTE}_{contr} = {\sum }_{t = 1}^{{t}_{f}} \frac{\vert {y}_{contr}^{*} - {y}_{t} \vert}{{y}_{contr}^{*}} , \qquad ( 7 )$$

t_{f} represents a maximum number of iterations of an end-side controller, and t represents a tth iteration, with a value from 1 to t_{f}; yₜ represents a value of a controlled variable at a tth iteration of the end-side controller; and yₜ_{_{f}} represents a value of the controlled variable at a t_{f}th iteration of the end-side controller.

Based on the final evaluation result, the AI technology evaluation system can uninterruptedly monitor and adjust a incineration process around the clock to reduce discharged pollutants.

Each embodiment in the description is described in a progressive mode, each embodiment focuses on differences from other embodiments, and references can be made to each other for the same and similar parts between embodiments.

Specific examples are used herein for illustration of the principles and implementations of the present disclosure. The description of the foregoing embodiments is used to help understand the method of the present disclosure and the core principles thereof. In addition, those of ordinary skill in the art can make various modifications in terms of specific implementations and scope of application in accordance with the teachings of the present disclosure. In conclusion, the content of the description shall not be construed as limitations to the present disclosure.

What is claimed is:

1. An artificial intelligence (AI) evaluation method for municipal solid waste incineration (MSWI), comprising:
obtaining, by a synchronous publishing system of multimodal historical data, a first data source and a second data source, wherein the first data source and the second data source both comprise: environmental index data, a controlled variable, a manipulated variable, left grate flame video data, and right grate flame video data, and wherein the environmental index data comprises amounts of SO₂, NOₓ, CO, and CO₂ in a incineration process, the controlled variable comprises a trace pollutant, a furnace temperature, and a flame combustion state, and the manipulated variable comprises a feed rate, a grate speed, a primary/secondary air volume, and an air temperature,
performing, by an AI-driven modeling system of multimodal data, quantitative modeling on the first data source, to obtain a model set, wherein the model set comprises: a detection model, a prediction model, a recognition model, a combustion line quantification model, a first optimization model, and a second optimization model,
implementing, by an AI control system of an end-side multiple-input multiple-output loop, a closed-loop operation of the AI control system of an end-side multiple-input multiple-output loop,
implementing, by an AI control system for edge-side safety isolation, closed-loop control of a virtual controlled-object of an edge-side physical isolation mechanism by the second data source,
implementing, by an AI optimization system for cloud-side safety isolation, closed-loop optimization for the virtual controlled-object based on a cloud-side forward and reverse safety isolation mechanism,
evaluating, by an AI technology evaluation system, the AI-driven modeling system of multimodal data, the AI control system of an end-side multiple-input multiple-output loop, the AI control system for edge-side safety isolation, the AI optimization system for cloud-side safety isolation, to obtain a final evaluation result; and
based on the final evaluation result, uninterruptedly monitoring and adjusting, by the AI technology evaluation system, the incineration process to reduce discharged pollutants;
wherein the AI-driven modeling system of multimodal data, the AI control system of an end-side multiple-input multiple-output loop, the AI control system for edge-side safety isolation, and the AI optimization system for cloud-side safety isolation are all connected to the AI technology evaluation system, and the AI-driven modeling system of multimodal data is connected to the AI optimization system for cloud-side safety isolation and the synchronous publishing system of multimodal historical data, the synchronous publishing system of multimodal historical data is connected to the AI control system for edge-side safety isolation, and the AI control system for edge-side safety isolation is connected to the AI control system of an end-side multiple-input multiple-output loop and the AI optimization system for cloud-side safety isolation.

2. The AI evaluation method for municipal solid waste incineration (MSWI) according to claim 1, wherein the synchronous publishing system of multimodal historical data comprises:
a network time synchronization service subsystem, and a subsystem for publishing historical structural data, a subsystem for publishing a historical left grate flame video, and a subsystem for publishing a historical right grate flame video that are all connected to the AI-driven modeling system of multimodal data and the network time synchronization service subsystem; and
the network time synchronization service subsystem is configured to unify clock signals of the subsystem for publishing historical structural data, the subsystem for publishing a historical left grate flame video, and the subsystem for publishing a historical right grate flame video,
the network time synchronization service subsystem is configured to simulate, in real time, publishing of the environmental index data, the controlled variable, and the manipulated variable based on the clock signals,
the subsystem for publishing a historical left grate flame video is configured to simulate, in real time, publishing of the left grate flame video data based on the clock signals, and
the subsystem for publishing a historical right grate flame video is configured to simulate, in real time, publishing of the right grate flame video data based on the clock signals.

3. The AI evaluation method for municipal solid waste incineration (MSWI) according to claim 2, wherein the AI-driven modeling system of multimodal data comprises:
a subsystem for structural modeling processing on multimodal data, a difficultly-to-be-measured parameter detection subsystem, a key process parameter prediction subsystem, a combustion state recognition subsystem, a combustion line state quantification subsystem, an environmental index optimization modeling subsystem, and a manipulated variable optimization modeling subsystem; and
the subsystem for structural modeling processing on multimodal data is configured to perform physical feature extraction and neural network feature extraction on the first data source, to obtain multimodal structural data,
the difficultly-to-be-measured parameter detection subsystem is configured to construct the detection model based on the multimodal structural data,
the key process parameter prediction subsystem is configured to construct the prediction model based on the multimodal structural data,
the combustion state recognition subsystem is configured to construct the recognition model based on the multimodal structural data,
the combustion line state quantification subsystem is configured to construct the combustion line quantification model based on the multimodal structural data,
the environmental index optimization modeling subsystem is configured to construct the first optimization model based on the multimodal structural data, and
the manipulated variable optimization modeling subsystem is configured to construct the second optimization model based on the multimodal structural data.

4. The AI evaluation method for municipal solid waste incineration (MSWI) according to claim 2, wherein the AI control system of an end-side multiple-input multiple-output loop comprises:
a subsystem for aid decision-making of an operation parameter, a process monitoring subsystem, a loop control subsystem, and a virtual controlled-object subsystem; and
the subsystem for aid decision-making of an operation parameter is configured to: acquire an operation parameter, and transmit the operation parameter to the process monitoring subsystem,
the process monitoring subsystem is configured to perform multi-loop AI control on the operation parameter,
the loop control subsystem is configured to implement a plurality of different types of loop control programs, and
the virtual controlled-object subsystem is configured to simulate an actuator, a controlled-object, and an instrumentation device of an MSWI process that is difficult to be constructed in a laboratory.

5. The AI evaluation method for municipal solid waste incineration (MSWI) according to claim 4, wherein the AI control system for edge-side safety isolation comprises:
a subsystem for forward isolation for edge-side data acquisition, an edge-side AI-enabled control subsystem, and a subsystem for reverse transmission of an edge-side operation parameter; and
the subsystem for forward isolation for edge-side data acquisition is configured to: acquire structural data, and publish the structural data to the edge-side AI-enabled safety control subsystem,
the edge-side AI-enabled control subsystem is configured to transmit structural data processed by an AI algorithm to the subsystem for reverse transmission of an edge-side operation parameter, and
the subsystem for reverse transmission of an edge-side operation parameter is configured to output the structural data to the subsystem for aid decision-making of an operation parameter.

6. The AI evaluation method for municipal solid waste incineration (MSWI) according to claim 4, wherein the AI technology evaluation system comprises:
a subsystem for comprehensive evaluation of an AI technology for municipal solid waste incineration, a subsystem for evaluation of an AI-driven modeling algorithm for multimodal data, a subsystem for evaluation of a cloud-side AI optimization algorithm for multiple types of furnaces, a subsystem for evaluation of an edge-side AI control algorithm for multiple types of furnaces, and a subsystem for evaluation of an end-side AI control algorithm for multiple types of furnaces; and
the subsystem for evaluation of an AI-driven modeling algorithm for multimodal data is configured to: evaluate the AI-driven modeling system of multimodal data, to obtain a first evaluation sub-result,
the subsystem for evaluation of an end-side AI control algorithm for multiple types of furnaces is configured to: evaluate the AI control system of an end-side multiple-input multiple-output loop, to obtain a second evaluation sub-result,
the subsystem for evaluation of an edge-side AI control algorithm for multiple types of furnaces is configured to: evaluate the AI control system for edge-side safety isolation, to obtain a third evaluation sub-result,
the subsystem for evaluation of a cloud-side AI optimization algorithm for multiple types of furnaces is configured to evaluate the AI optimization system for cloud-side safety isolation, to obtain a fourth evaluation sub-result, and
the subsystem for comprehensive evaluation of an AI technology for municipal solid waste incineration is configured to obtain a final evaluation result based on the first evaluation sub-result, the second evaluation sub-result, the third evaluation sub-result, and the fourth evaluation sub-result.

7. An artificial intelligence (AI) evaluation system for municipal solid waste incineration (MSWI), comprising:
at least one processor;
a memory storing programming instructions, that when executed by the at least one processor, cause the at least one processor to execute the AI evaluation method for municipal solid waste incineration (MSWI) according to claim 1.
